(19) United States
(12) Patent Application Publication
(10) Pub. No.: US 2023/0234839 A1
(43) Pub. Date: Jul. 27, 2023

(54) Hydrogen and Power Production with Sorbent Enhanced Reactor Steam Reformer and Carbon Capture

(71) Applicant: Wormser Energy Solutions, Inc., Avon, CT (US)

(72) Inventors: Douglas M. Todd, Galway, NY (US); Chris Higman, Chippenham (GB)

(73) Assignee: Wormser Energy Solutions, Inc., Avon, CT (US)

(21) Appl. No.: 18/158,334

(22) Filed: Jan. 23, 2023

Related U.S. Application Data
(60) Provisional application No. 63/302,840, filed on Jan. 25, 2022.

(51) Int. Cl. C01B 3/02

(52) U.S. Cl. CPC C01B 3/02; C01B 2203/0283; C01B 2203/0272; C01B 2203/0415; C01B 2203/0455; C01B 2203/0485; C01B 2203/0475; C01B 2203/0827; C01B 2203/0872; C01B 2203/1052; C01B 2203/1211; C01B 2203/1258; C01B 2210/0051; C01B 2210/0025; C01B 2210/0098

(57) ABSTRACT

An apparatus for generating hydrogen from solid carbonaceous feed stock for production of electricity, chemicals, or fuels using all-steam gasification includes a micronized char preparation system comprising a devolatilizer and an indirect all-steam gasifier generating syngas. A syngas cooler is configured to at least partial quench the syngas and can to produce steam. A syngas clean up system removes ash and residual carbon, a carbon-capture system includes a water gas shift system and CO₂ removal system. A pressure swing absorber (PSA) generating tailgas. An oxygen-fueled burner receives tailgas from the PSA and provides heat to a sorbent enhanced reformer (SER) battery limit system. A hydrogen cooler receives tailgas from the PSA that provides heat to the SER battery limit system. A CO₂ cooler receives tailgas from the PSA that providing heat to the sorbent enhanced reformer battery limit system.

### CROSS REFERENCE TO RELATED APPLICATIONS

The present application is a non-provisional application of U.S. Provisional Patent Application No. 63/302,840, entitled “Hydrogen and Power Production with Sorbent Enhanced Reactor Steam Reformer and Carbon Capture” filed on Jan. 25, 2022. The entire content of U.S. Provisional Patent Application No. 63/302,840 is herein incorporated by reference.

The section headings used herein are for organizational purposes only and should not be construed as limiting the subject matter described in the present application in any way.

### INTRODUCTION

Global warming concerns about CO₂ greenhouse gas accumulation in the atmosphere continue to grow. Atmospheric concentrations of CO₂ are higher now than in any of the last several hundred thousand years. CO₂ emissions from fossil fuel energy generation systems are a major culprit in the recent few decades of increasing CO₂ in the atmosphere. At the same time, the demand for and use of fossil fuels worldwide continues to grow. Even with major increases in renewables and nuclear energy sources, the growth of fossil fuel consumption continues to rise. As such, there is a significant need for efficient and effective low-carbon technologies, especially for power generation from Hydrogen and/or chemical production.

Integrated gasification combined cycle (IGCC) technology is the cleanest way to make energy from coal and other solid carbonaceous feedstocks. Gasification with Carbon Capture, Utilization and Storage (CCUS) is beneficial to the environment, resulting in less pollution, reduced carbon dioxide emission, less solid waste, and lower water use. An IGCC power plant with (CCUS) makes and burns hydrogen rich syngas in a turbine to produce electricity. Blends of biomass fuel can produce Net Negative Carbon (NNC). The excess heat is captured to power a second turbine that produces more electricity, resulting in high-efficiency power generation. Gasification of various solid carbonaceous fuels to produce chemicals including hydrogen, fertilizers, methanol, fuels, and many other chemicals is common today.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a system block diagram of an all-steam gasification for Variable Renewable Energy (VRE) Power and Hydrogen PolyGeneration (HP) applications with a Carbon Capture (CC) system according to the present teaching.

FIG. 2 illustrates a hydrogen and power generating system with a modified Sorbent Enhanced Reactor (SER) steam reformer and carbon capture according to the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

Global warming and climate change issues are requiring that coal power plants world-wide add expensive controls to capture and store CO₂ in order to meet desired emission rates. Current technologies, such as IGCC with carbon capture and storage (CCS) for coal plants, have proven uneconomical without subsidies. The additional power required to run the carbon capture systems also reduces efficiency, and consequently widespread adoption has not occurred. This has led to the shutdown of older coal plants and cancellation of many new plants. It is understood by many experts that coal is a valuable energy source to assist in transitioning the world to renewable energy sources. By using carbon capture in combination with the teachings of the present invention, coal and like materials can be economically utilized and can even provide support to mitigate Renewable Variable Energy (RVE).

The present teaching relates to improvements in all-steam gasification system with carbon capture, which can substantially improve both cost and efficiency, and hasten widespread adoption of integrated gasification for combined cycle (IGCC) technology and hydrogen needed for other industrial applications. Various aspects of the present teaching relate to the combination and process intensification of matching technologies. For example, oxygen generated from steam rather than an air separation plant is used both for gasification and to produce hydrogen comes. Using all-steam gasification (ASG) combined with an indirect gasifier has numerous advantages because it can supply a source of heat for gasification by the complete combustion of fuel using air. This is accomplished by using an indirect gasifier to keep the products of combustion from mixing with the syngas allowing nitrogen free syngas. This process increases the amount of net hydrogen produced per pound of carbon in the gasifier. Since hydrogen is a carbon-free fuel, the increased yield of hydrogen and the use of air instead of oxygen increases IGCC plant efficiency with carbon capture, from about 32% for a conventional IGCC system with carbon capture, to about 40% with the new system. This is greater than 20% more power per pound of coal while capturing more than 90% of the carbon for storage. Due to unique designs in each of the subsystems, there is also an even greater reduction of cost, for both fuel and capital.

A carbonaceous fuel gasification system according to the present teaching includes a micronized char preparation system comprising a devolatilizer that receives solid carbonaceous fuel, hydrogen, oxygen, and fluidizing steam. For example, the solid carbonaceous fuel can be coal, or blends of coal with biomass, municipal solid waste (MSW) and/or plastic material. The micronized char preparation system produces micronized char, steam, volatiles, and hydrogen at one or more outlets. The average size of the micronized char is in the 10-50-micron range. The micronized char preparation system can also include a counter-flow char cooler that preheats steam as it cools the char, a pressure let-down valve, a pulverizer that reduces the average size of the micronized char to under 10μ, and an airlock that re-pressurizes the micronized char to the inlet.

In some systems, the devolatilizer comprises a heated pressure vessel comprising an inlet for injecting fluidizing steam, and at least one outlet for removing volatiles and coarse char. The char preparation system can include cyclones that separate course char and ash from gases. The cyclones have an outlet that is coupled to an input of an indirect gasifier that is positioned downstream of the devolatilizer. Process intensification that combines multiple functions into a single device has been used to include a micronizing function in this device.

The indirect gasifier includes a vessel comprising a gasification chamber that receives the micronized char from the micronized char preparation system, and that receives a conveying fluid, and steam. The gasification chamber is also sometimes referred to as a gasifier. In this embodiment, the indirect gasifier receives volatiles from the outlet of the micronized char preparation system. In some embodiments, the gasification chamber receives steam from an outlet of the micronized char preparation system. Also, in some embodiments, the gasification chamber (gasifier) has an outlet that is coupled to an inlet of a syngas cooler/heat recovery system so that the heat recovery system receives steam from the gasification system. The gasification system produces syngas, ash, and steam at one or more outlets.

The indirect gasifier also includes a combustion chamber. The combustion chamber is sometimes referred to as a combustor. The combustion chamber receives a mixture of hydrogen and oxidant and burns the mixture of hydrogen and oxidant to provide heat for gasification and for heating incoming flows, thereby generating Products of Combustion (POC)—steam and nitrogen. For example, the oxidant can be air. In some embodiments, the oxidant is oxygen or oxygen mixed with CO₂ using syngas as the fuel. The heat for gasification is transferred from the combustion chamber to the gasification chamber by circulating refractory sand. In some embodiments, the steam and nitrogen or steam and CO₂ generated by the indirect gasifier's combustor are directed to a gas turbine power generation system. In some embodiments, the steam and nitrogen generated by the combustion chamber of the indirect gasifier are directed to an expander connected to an electrical generator, to stack condensers in a power block, and is then exhausted at a system stack.

In various embodiments, the carbonaceous fuel gasification system can further include cyclones that are positioned downstream of the gasifier to separate sand and ash from gases. Also, the carbonaceous fuel gasification system can further include a syngas cooler having an inlet coupled to the outlet of the gasification chamber of the indirect gasifier, where the syngas cooler cools the syngas. In some embodiments, steam can be generated at an outlet. A syngas clean up system having an input that receives the cooled syngas from the outlet of the syngas cooler can be used to remove impurities. One particular embodiment uses a Warm Gas Clean Up (WGCU) to fit with the capture system

A carbon capture system having an input that is coupled to the outlet of the syngas clean-up system can be used to generate carbon dioxide and hydrogen. Also, in some embodiments, a solid fuel-to-liquids system or other chemical making device is coupled to the outlet of the carbon capture that provides hydrogen.

There are numerous advantages to the carbonaceous fuel gasification system configuration of the present teaching including that the char preparation system eliminates the previous counter-flow char cooler that preheats steam as it cools the char, along with the pressure let-down valve, the pulverizer mill that reduces the average size of the micronized char to under 10μ, and the airlock that re-pressurizes the micronized char to the gasifier inlet pressure. This greatly simplifies and reduces the cost of the system leading to a highly practical commercial system.

In addition, the all-steam gasification system produces a larger quantity of hydrogen per pound of coal or other feedstock compared with other known methods. The use of air and hydrogen for gasification heat eliminates the large expensive air separation plant for producing oxygen, normally used for such systems, significantly improving efficiency and cost. An indirect gasifier enables nearly nitrogen-free hydrogen necessary for polygeneration of liquids and chemicals while maintaining power-only and Coal-to-Chemicals (CTX)-only-modes by keeping air from mixing with the critical streams.

Furthermore, the use of micronized char produced in a devolatilizer/char preparation system helps to enable gasification of the feedstock in seconds. This significantly reduces the gasification plant size and provides increased capacity in modularized equipment. A calcium looping system with integral water gas shift, using high temperature fixed beds and limestone-based sorbents enhances the overall carbon capture system and can result in pipeline-quality, high-pressure CO₂. Sorbent Enhanced Reforming, (SER), Calcium Looping (CaL) activated Methyl Diethanol Amine (aMDEA) can be used. Such systems avoid the need for steam to regenerate the sorbents used to capture carbon dioxide. Integrated high temperature heat recovery systems using specialized high temperature heat exchangers support the overall system with very high efficiency. Finally, such systems can utilize known warm-gas clean-up systems that produce near-zero emissions, easing air pollution while reducing temperature cycling.

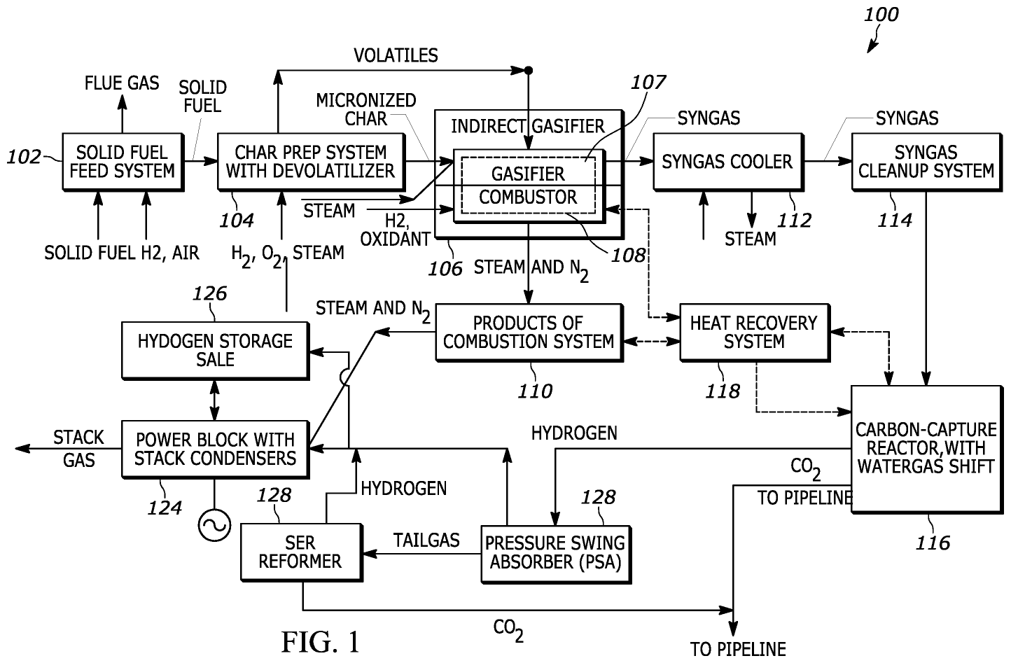

FIG. 1 illustrates a system block diagram 100 of an all-steam gasification for Variable Renewable Energy (VRE) Power and Hydrogen PolyGeneration applications with a carbon capture system according to the present teaching. The hydrogenation system along with carbon capture can run at 100% capacity full time while electric power can be varied to meet VRE demand allowing high pressure excess hydrogen to be stored or used at the site for other carbon free products. The all-steam gasification with carbon capture system 100 is suitable for use in polygeneration. In polygeneration, power and chemicals are made simultaneously from solid fuels, such as coal. Although many aspects of the present teaching are described in connection with the use of coal, one skilled in the art will appreciate that the present teaching is not limited to coal and that numerous other solid fuels can also be used. For example, blends of coal, peat, wood, wood pellets, charcoal, municipal solid waste, and plastics can be used to provide net negative carbon.

The embodiment of the all-steam gasification with carbon capture system 100 shown in FIG. 1 includes a coal feed system 102 that takes in coal to feed the coal to the system at pressure. Some embodiments of the coal feed system 102 use a rotary valve feeder or dry solids pump and a fluid bed coal drier with a mixer. The coal feed system 102 provides solid fuel to a char preparation system 104. The char preparation system 104 includes a devolatilizer with an internal pulverizing function.

One feature of the present teaching is the production of micronized char that advantageously speeds the gasification process and reduces system contamination. The char preparation system 104 prepares micronized char from the coal received from the coal feed system 102 and transfers it to the indirect gasifier 106. To produce micronized char from embodiments of the char preparation system that use coal, the char preparation system 104 receives crushed coal with a size suitable for fluidization. In some embodiments, the fluidization size is less than ¼-inch. Then the crushed coal is micronized in the devolatilizer.

Although it is possible to gasify coal directly without using a char preparation system 104, it is preferable in some systems to first convert the coal into char, then pulverize the coal and ash and then gasify the micronized char. This is because char is much more brittle than coal since most of the interior of the coal particles have been hollowed out by pyrolysis. Pyrolysis produces char particles with a range of geometries. Char particle geometry may comprise a thin-shell sphere. The char particle geometry may also be similar to Swiss cheese in form. The hollowed-out geometry causes char particles to break into far smaller pieces when pulverized than coal. Particles below ten microns are readily achieved. Some particles of pulverized char are ten-times smaller in diameter, and 1000-times smaller in volume, then pulverized coal. The small size of pulverized char particles hastens gasification, which increases viability.

A second feature of using micronized char of the present teaching is that it is non-wetting. Micronized char is non-wetting because the particles remain entrained in the gases in which they flow, rather than colliding with each other or other surfaces. The non-wetting feature avoids the fouling, clinkering, agglomeration, and corrosion common in prior art coal-fired power systems using pulverized coal as the solid fuel.

The indirect gasifier 106 of the present teaching produces syngas from the micronized char. Prior art indirect gasifiers have been used principally to make methane from biomass. As illustrated in FIG. 1, the heat for the reactions in indirect gasifier 106 is created by combustion in one chamber 108, and gasification occurs in the other chamber 107. The combustion chamber of the gasifier/combustor 108 is sometimes referred to as a combustor. The gasifier chamber of the indirect gasifier 107 may also be referred to as a gasifier. The gases emerging from each chamber are kept separated. The heat transfer between the chambers required for gasification is provided by circulating hot solids. The hot solids are heated in the combustor 108 and cooled by gasification in the gasifier 107. In some embodiments, the hot circulating solid is flowing refractory sand.

One feature of using the indirect gasifier 107 of the present teaching is that it makes all-steam gasification (ASG) with air possible for applications where nitrogen free syngas is required. Using ASG with air is desirable because indirect gasification eliminates the need for an oxygen plant, also known as an air separation unit (ASU) for fuels production. This is because the products of combustion (POC) are kept separate from the syngas, thereby avoiding the contamination of the syngas by nitrogen in the combustion air. Eliminating the need for a large oxygen plant saves a considerable amount of cost in construction of the system as reducing the space requirements. Also, indirect gasification creates an improvement in both the efficiency, in the form of a large reduction in auxiliary power required for the ASU, and the costs of gasification systems used to produce chemicals resulting in considerable ongoing cost savings. An additional important feature of using the indirect gasifier 106 of the present teaching is that the use of hydrogen in the combustion chamber for providing gasification heat by complete combustion allows all the carbon in the coal to be used to produce the maximum amount of hydrogen per pound of coal.

The indirect gasifier 106 receives steam and micronized char from the char preparation system 104. The indirect gasifier combustor 108 receives oxidants and hydrogen. The indirect gasifier also uses volatiles and methane provided by the char preparation system 104. The indirect gasifier combustor 108 produces steam and nitrogen as products of combustion 110. The indirect gasifier produces syngas that is provided to a syngas cooler 112. The syngas cooler 112 cools hot syngas leaving the indirect gasifier 107 to the temperature required by the syngas clean up system 114.

The syngas clean up system removes pollutants and sends the syngas to a carbon-capture reactor 116. The carbon capture system 116 uses process intensification to combine multiple functions in the carbon-capture reactor 116. These functions can include (1) Water Gas Shift (WGS) to produce hydrogen from CO and steam; and (2) activated Methyl Diethanol Amine or similar chemistry to capture CO₂ and release CO₂. The water gas shift and carbon-capture reactor 116 produces CO₂ that is sent to a pipeline as show in FIG. 1. The carbon-capture reactor with water gas shift 116 also produces hydrogen and/or high-hydrogen syngas.

An integrated high temperature heat recovery system 118 integrates the steam for the gasifier and throttle steam for a steam turbine used for power generation. The heat recovery system 118 may recover the high temperature heat from the water gas shift reaction in the carbon-capture reactor 116. The indirect gasifier 106 can use heat provided by the heat recovery system 118. Also, the carbon-capture reactor 116 can use heat provided by the heat recovery system 118.

It is anticipated that many all-steam gasification with carbon capture systems that use the char preparation system according to the present teaching have the ability to supply hydrogen to produce chemicals, such as liquid fuels, methanol, ammonia, and urea, in addition to providing power. The method and apparatus of the present teaching have the ability to produce power and excess hydrogen especially during periods of low power demand.

In some embodiments of the system of the present teaching, the hydrogen from the carbon-capture reactor is also sent to a power block 124. The power block 124 includes a stack condenser for the stack gas that recovers the moisture created by the combustion of the hydrogen. The power block 124 uses steam and N₂ from the products of combustion 110. This is important to dilute the hydrogen fuel to reduce flame temperatures to temperatures suitable for modern gas turbines. The stack condensers can provide a system with low water usage compared to conventional IGCCs because the power block uses the hydrogen as fuel so there is a large component of water vapor in the gas turbine stack. Condensation is made feasible by the very low sulfur dioxide in the syngas due to the high efficiency of the syngas clean up system 114. The very low sulfur dioxide content syngas also eliminates the corrosion of the stack that could otherwise occur. The power block 124 typically would include a relatively large sized steam turbine to accommodate the many steam sources other than the gas turbine heat recovery steam generator.

Air extraction from a gas turbine for process air flows is used in many known conventional integrated gasification combined cycle (IGCC). The optimal amount of air extraction depends on economic and operating considerations. Some embodiments of the power block 124 of the present teaching use a different amount of air extraction as compared to known power blocks. This is, at least in part, because hydrogen is used as the principal fuel and the products of combustion system 110 flows of steam and nitrogen are returned to the gas turbine in the power block 124. As such, the optimum amount of air extraction is different from any known IGCC air extraction systems. Embodiments of the power block 124 used for various polygeneration applications such as heating, cooling and electricity production, will also use a different optimum amount of air extraction than most known IGCC.

The power block 124 interfaces with a hydrogen storage unit 126 that is used to store excess hydrogen for sale or to maintain power block reliability at very high levels. In this manner, the power block can raise or lower output instantaneously to meet modern RVE requirements.

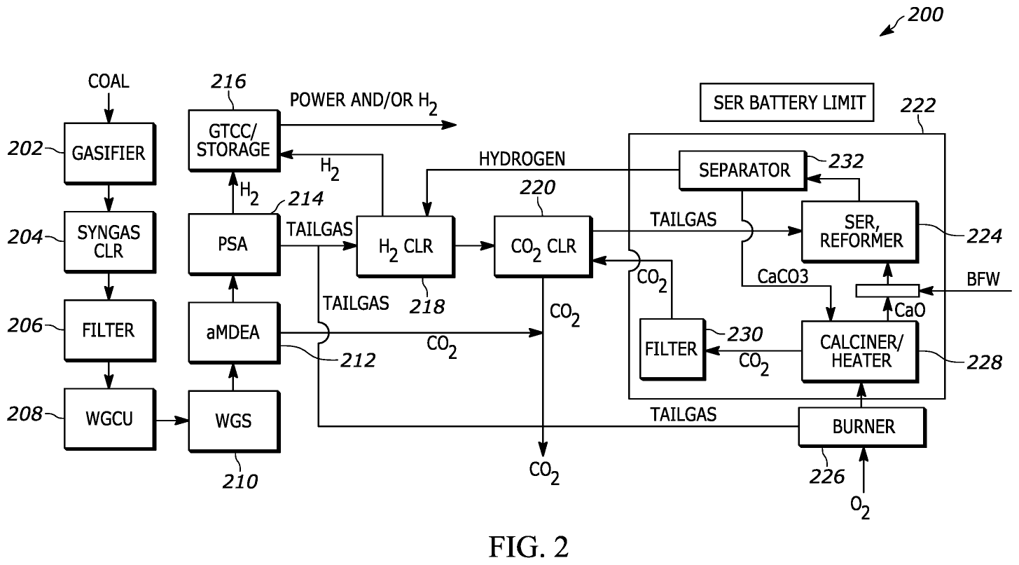

The carbon-capture reactor with water gas shift 116 also provides hydrogen (high-hydrogen syngas) to a Pressure Swing Absorber (PSA) 128 that purifies the hydrogen and generates tailgas containing methane that needs to reformed. The tailgas is sent to a Sorbent Enhanced Reformer (SER) that is described further in connection with FIG. 2. The sorbent enhanced reformer processes the tailgas and generates hydrogen that is provided to the power block 124 and provided to the hydrogen storage unit 126, for use and for sale. It also provides CO₂ to the pipeline or other uses.

Gas treatment arrangements are used to generate raw hydrogen. Gas treatment arrangements including desulfurization, CO shift, and CO₂ removal to generate raw hydrogen. The apparatus and method of the present teaching uses, for example, Warm Gas Desulfurization (WGDS), Clean Gas Shift (CGS) with iron catalyst and an amine-based CO₂ removal system, which is typically activated methyldiethanolamine. Alternatively, Sour Shift (SS) with cobalt-molybdenum catalyst, selective physical acid gas removal, for example, Selexol (dimethyl ethers of polyethylene glycols) or Rectisol (methanol based solvent) for separate desulfurization and CO₂ removal can be used.

The carbon capture system is preceded by a shift reactor, which converts the CO in syngas into hydrogen and CO₂. The CO₂ is then captured by the acid-gas system.

The water-gas shift reaction is sometimes also referred to as the shift reaction. The water-gas shift reaction is an important reaction for carbon capture and for generating clean energy and chemical production from coal and other carbonaceous fuels. The well-known shift reaction is the conversion of CO and H₂O into H₂ and CO₂. The shift reaction can operate with a variety of catalysts and at a range of temperatures.

Known low temperature and high pressure gasification systems for certain applications produce a syngas with methane contents in the range of 10-20%. The methane can lower carbon capture rates to as low as 70%. To meet proposed world standards for CO₂ emissions (above 90%), reforming of the methane to hydrogen and CO₂ will be necessary.

FIG. 2 illustrates a hydrogen and power generating system 200 with sorbent enhanced reactor steam reforming and capture according to the present teaching. The methods and apparatus of the present teaching provide an economical way to convert the undesirable methane to more hydrogen. Some embodiments of the present teaching include modifications for an SER that can be provided by a different manufacturer. The methods and apparatus of the present teaching also provides very significant improvements in efficiency, size reduction for modularity and especially cost due to the method of heating the calciner and integration of the SER with gasification.

Overall, the system 200 receives coal, air, oxygen, and boiler feed water (BFW) and generates power and/or hydrogen while capturing CO₂. The system 200 includes a gasification unit with a carbon capture system and an additional Sorbent Enhanced Reforming (SER) system with integrated methane reforming function shown on FIG. 2 as SER. One aspect of the present teaching is to use a commercial Sorbent Enhanced Reactor (SER) for Natural Gas (NG SER) to provide the functions of reforming methane. The overall capture system is sometimes separated into different commercial components, such as Water Gas Shift (WGS) components, carbon capture components (like aMDEA), and a Pressure Swing Absorber (PSA). The PSA separates the methane so that it can be converted separately in the SER unit to hydrogen and CO₂ more economically. Reforming of the methane is sometimes called steam reforming (CH₄+2H₂O>CO₂+4 H₂). The water gas shift (WGS) reaction is (CO+H₂O)> to (CO₂+H₂) and the CO₂ can be captured.

The system 200 receives coal at a gasifier 202 as described in connection with FIG. 1. The syngas created in the gasifier with all of the ash leaves the gasifier 202 at a temperature that is in the range of 980 degrees C. A syngas cooler 204 reduces the temperature of the syngas to a temperature that is in the range of 425 degrees C. A filter 206 removes the ash from the gasified coal. A warm gas clean-up unit reactor 208 scrubs the gases increasing the temperature to the 525-degree C. range. A WGS reactor 210 shifts the syngas to form hydrogen and CO₂. A carbon capture unit 212, such as an activated Methyl Diethanol Amine (aMDEA) unit, separates CO₂ that is provided to an outlet and passes other gasses to a Pressure Swing Absorber (PSA) 214.

The pressure swing absorber 214 purifies the raw hydrogen and produces a methane containing tailgas as a by-product. The purified Hydrogen is provided to a Gas Turbine Combined Cycle (GTCC) unit 216 to provide power and excess hydrogen. The tailgas, which is mostly methane, that is produced by the pressure swing absorber 214 is heated in a hydrogen cooler 218 which provides hydrogen to the gas turbine combined cycle unit. The tailgas is then further heated by a CO₂ cooler 220 while providing Cooled CO₂ to the pipeline. Separately, cool tailgas from the pressure swing absorber is the input to the special oxygen fired burner providing heat to the SER Calciner 228. The heated tailgas from system 220, which can be in the temperature range of about 600 degrees C. is provided to one input of the Sorbent Enhanced Reforming (SER) unit 224. The specific design and arrangement of the heating and cooling system is critical to the efficiency improvement. Boiler Feed Water is provided to another input of the SER battery limit system unit 222.

Recent technology development for the SER battery limit system (222) shows that an optimum approach to calcium looping is to operate the carbonator at a higher temperature than the calciner as opposed to known technology that uses adiabatic calcium looping. Systems of the present teaching require a method of providing heat to the calciner during continuous operation that is more economical because it uses direct firing of the tailgas/methane with oxygen rather than indirect heating. A burner 226 positioned external to the SER battery limit system 222 uses tailgas from the Pressure Swing Absorber (PSA) 214 and oxygen to heat to a Calciner/Heater 228 to provide a temperature in a range of 900 degrees C.

The specific design and arrangement of the burner 226 and indirect heating system is critical to the efficiency improvement and operability of the plant. The burner 226 is located at the bottom of the calciner. Oxygen and tailgas flowing to it are controlled to provide the optimum temperature of the calciner ˜900 degrees C. The burner 226 uses oxygen as opposed to air so combustion products can be mixed with the outgoing CO₂. The small burner replaces the very large calciner heater. The Calciner/Heater 228 includes a calciner reactor that contains CaO and CaCO₃. The Calciner/Heater 228 provides CO₂ at a temperature of about 900 degrees C. and at a pressure of 1.3 bar to a filter 230 which cleans up the CO₂ and provides it to the CO₂ cooler 220.

The Calciner/Heater 228 provides CaO that is mixed with boiler feed water and heated to the SER Reformer 224. The gaseous output of the sorbent enhanced reformer 224 is provided to a separator 232. The separator 232 separates CaCO3 solids and provides hydrogen at about 650 degrees C. to the hydrogen cooler 218. It should be understood that the temperature and pressures provided in this description illustrate one particular example of operation and are in no way limiting.

The integration system between the all steam integrated gasification combined cycle and the hydrogen production is unique and requires all three aspects of the present teaching including hydrogen and CO₂ coolers for efficiency, multi staged PSA for carbon capture rates of 90-97%, and direct firing of the modified SER calciner. The result is that the integration system provides a plant that can serve the climate control needs of the world for green power and can also provide hydrogen to fit with renewable energy at a very substantial reduction in cost compared with other known systems. For example, the methods and apparatus of the present teaching are particularly useful for the concept of hydrogen hubs

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. An apparatus for generating hydrogen from solid carbonaceous feed stock for production of electricity, chemicals, or fuels using all-steam gasification, the apparatus comprising:
a) a micronized char preparation system comprising a devolatilizer;
b) an indirect all-steam gasifier having an input that receives micronized char from the devolatilizer, the indirect all-steam gasifier generating syngas at an output;
c) a syngas cooler having an input that is coupled to the output of the indirect all-steam gasifier, the syngas cooler configured to at least partial quench the generated syngas and can produce steam;
d) a syngas clean up system having an input coupled to the output of the syngas cooler, the syngas clean up system removing ash and residual carbon from the partially quenched syngas;
e) a carbon-capture system comprising a water gas shift system and CO₂ removal system having an input that is coupled to an output of the syngas clean up system;
f) a pressure swing absorber having an input that is coupled to an output of the carbon-capture system, the pressure swing absorber generating tailgas at an output;
g) a sorbent enhanced reformer battery limit system having an input that is coupled to the output of the pressure swing absorber;
h) an oxygen-fueled burner having an input that receives tailgas from an output of the pressure swing absorber and that provides heat to the sorbent enhanced reformer battery limit system;
i) a hydrogen cooler having an input that receives tailgas from the output of the pressure swing absorber and that provides heat to the sorbent enhanced reformer battery limit system; and
j) a CO₂ cooler having an input that receives tailgas from the output of the pressure swing absorber and that provides heat to the sorbent enhanced reformer battery limit system.

2. The apparatus of claim 1 wherein the micronized char preparation system is configured to pyrolyze the solid carbonaceous feed stock into char and configured to pulverize the char to reduce an average size of the micronized char.

3. The apparatus of claim 2 wherein the average size of the micronized char is in a range between 10 and 50 microns.

4. The apparatus of claim 1 wherein the solid carbonaceous fuel comprises at least one of coal, blends of coal with biomass, or municipal solid waste (MSW).

5. The apparatus of claim 1 wherein the indirect all-steam gasifier is configured to keep products of combustion from mixing with the generated syngas, thereby providing nearly nitrogen-free syngas.

6. The apparatus of claim 1 wherein the devolatilizer comprises a heated pressure vessel comprising an inlet for injecting fluidizing steam and at least one outlet for removing volatiles and micronized char.

7. The apparatus of claim 1 wherein the syngas clean up system comprises a filter.

8. The apparatus of claim 1 wherein the water gas shift system comprises an iron catalyst.

9. The apparatus of claim 1 wherein the water gas shift system comprises a sour-shift system with cobalt-molybdenum catalyst.

10. The apparatus of claim 1 wherein the water gas shift system comprises a selective physical acid gas removal system for separate desulfurization and CO₂ removal.

11. The apparatus of claim 10 wherein the selective physical acid gas removal system comprises dimethyl ethers of polyethylene glycols.

12. The apparatus of claim 10 wherein the selective physical acid gas removal system comprises a methanol based solvent.

13. The apparatus of claim 1 wherein the syngas clean up system comprises a warm gas clean up system.

14. The apparatus of claim 1 further comprising a second stage gasifier coupled to the output of the indirect all-steam gasifier and being configured to gasify residual carbon in ash to a level suitable for ash disposal.

15. The apparatus of claim 1 wherein the carbon-capture system comprises an amine-based CO₂ removal system.

16. The apparatus of claim 15 wherein the amine-based CO₂ removal system comprises an activated Methyl Diethanol Amine (aMDEA) system.

17. The apparatus of claim 1 wherein the pressure swing absorber is configured in stages to make all product available as pure hydrogen and allow control of carbon capture rate to between 90-97%.

18. The apparatus of claim 1 wherein the sorbent enhanced reformer battery limit system comprises a sorbent enhanced reformer.

19. The apparatus of claim 1 wherein the sorbent enhanced reformer battery limit system comprises a calcium looping system.

20. The apparatus of claim 1 wherein the sorbent enhanced reformer battery limit system comprising a calciner.

21. The apparatus of claim 20 wherein the oxygen-fueled burner is configured so that products of combustion exit with CO₂ from the calciner.

22. The apparatus of claim 20 wherein the sorbent enhanced reformer battery limit system comprises a calciner heater.

23. The apparatus of claim 1 wherein the sorbent enhanced reformer battery limit system comprises a solids filter.
